(19) United States
(12) Patent Application Publication
(10) Pub. No.: US 2023/0142985 A1
(43) Pub. Date: May 11, 2023

(54) DATA REDUCTION METHOD AND DATA PROCESSING DEVICE

(71) Applicant: POSTECH Research and Business Development Foundation, Pohang-si (KR)

(72) Inventors: Tae Hyun OH, Pohang-si (KR); Hyeon Woo NAM, Pohang-si (KR); Ye Bin MOON, Pohang-si (KR)

(73) Assignee: POSTECH Research and Business Development Foundation, Pohang-si (KR)

(21) Appl. No.: 17/976,682

(22) Filed: Oct. 28, 2022

(30) Foreign Application Priority Data
Nov. 5, 2021 (KR) 10-2021-0151683
Aug. 30, 2022 (KR) 10-2022-0109174

(51) Int. Cl. G06N 5/04; G06N 3/08

(52) U.S. Cl. CPC G06N 5/04; G06N 3/08

(57) ABSTRACT

Provided are a data reduction method and a data processing device. The data processing device includes a memory configured to store target data expressed as a vector matrix and instructions for performing control over data reduction and a processor configured to determine low-rank matrices W₁ and W₂ from which a target parameter matrix W is constructable. The target parameter matrix W is constructed as the Hadamard product between the low-rank matrices W₁ and W₂.

### CROSS-REFERENCE TO RELATED APPLICATION

This application claims priority to and the benefit of Korean Patent Application No. 10-2021-0151683, filed on Dec. 11, 2021 and Korean Patent Application No. 10-2022-0109174, filed on Aug. 30, 2022, the disclosure of which is incorporated herein by reference in its entirety.

### BACKGROUND

### Field of the Invention

The following description relates to a data reduction technique. In particular, the following description relates to a technique for calculating compressed data or a neural network layer using full-rank reduced parameterization.

This work was supported by Institute of Information & communications Technology Planning & Evaluation (IITP) grant funded by the Korea government(MSIT) (No. 2022-0-00124, Development of Artificial Intelligence Technology for Self-Improving Competency-Aware Learning Capabilities).

### Discussion of Related Art

Digital data is used in various fields such as signal processing, communication, artificial intelligence (AI), etc. In the digital data field, data reduction is an important issue in increasing processing speed and reducing communication costs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a data reduction method performed by a device including a processor and a memory configured to store instructions for controlling the processor to perform data reduction, the data reduction method including receiving, by the memory, data expressed as a vector matrix and determining, by the processor, low-rank matrices W1 and W2 from which a target parameter matrix W is constructable.

The target parameter matrix W may be constructed as an Hadamard product between the low-rank matrices W1 and W2, the low-rank matrix W1 may be constructed as an inner product of a matrix X1 having a size of m×r1 and a matrix Y1 having a size of n×r1, and the low-rank matrix W2 may be constructed as an inner product of a matrix X2 having a size of m×r2 and a matrix Y2 having a size of n×r2. Here, m, n, r1, and r2 may be natural numbers.

In another aspect, there is provided an inference method performed using a neural network model on a target layer lightened in accordance with the data reduction method among layers of the neural network by a device including a processor and a memory configured to store instructions for the processor to control an inference process employing the neural network model, the inference method including receiving, by the memory, low-rank matrices W₁ and W₂ for constructing a target parameter matrix W of the target layer, calculating, by the processor, an Hadamard product between the low-rank matrices W₁ and W₂ to construct the target parameter matrix W, and inputting, by the processor, input data or a feature transferred from a previous layer of the target layer to the target layer to make an inference.

In yet another aspect, there is provided a data personalization method performed by a device including a processor and a memory configured to store instructions for the processor to operate using global data and local data having a device-dependent feature, the data personalization method including receiving, by the memory, a low-rank matrix W₁ for the global data and a low-rank matrix W₂ for the local data which are determined in a data reduction process in accordance with the data reduction method of any one of claims 1 to 5, generating, by the processor, a target parameter matrix W as an Hadamard product between the low-rank matrices W₁ and W₂, and training, by the processor, the neural network model or making an inference based on the neural network model using the target parameter matrix W. The low-rank matrix W₁ for the global data is calculated as a result of learning from the global data by at least one device other than the device.

### BRIEF DESCRIPTION OF THE DRAWINGS

FIG. 1 is an example of general low-rank parameterization;

FIG. 2 is an example of full-rank reduced parameterization;

FIG. 3 is an example of federated learning to which full-rank reduced parameterization is applied;

FIG. 4 is an example of a model personalization technique employing full-rank reduced parameterization;

FIGS. 5(A), 5(B) and 5(C) show results of verifying the model personalization technique employing full-rank reduced parameterization;

FIG. 6 is an example of distributed learning to which full-rank reduced parameterization is applied;

FIG. 7 is an example of a neural network inference technique to which full-rank reduced parameterization is applied;

FIG. 8 is an example of a data compression technique to which full-rank reduced parameterization is applied;

FIG. 9 is an example of a data processing device that performs full-rank reduced parameterization; and

FIG. 10 is an example of a client that executes a certain application using reduced data.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The following description relates to a data reduction technology for reducing parameters in a specific data structure or model. For the convenience of description, model compression in a neural network will be mainly described. However, the following description is not limited to an application for reducing the parameters of a layer of the neural network. Further, various applications to which the following technology may be applied will be described below.

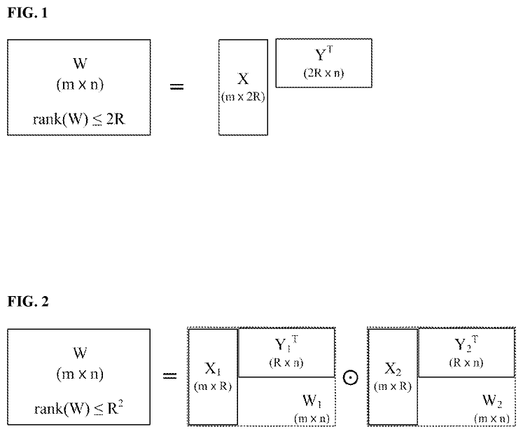

First, general low-rank parameterization will be described. FIG. 1 is an example of general low-rank parameterization.

Low-rank parameterization is a technology for reducing the number of parameters that constitute digital data or a neural network. With low-rank parameterization, the number of parameters is reduced, and thus the size of data or a model may be reduced.

Low-rank decomposition is a technology for reducing the number of parameters while minimizing the loss of information encoded. Low-rank parameterization may be used as the matrix decomposition in the compression of a pretrained neural network. Matrix decomposition can be applied to the kernels of convolutional layers, fully connected (FC) layers, etc.

It is assumed that there is a learned parameter matrix Wϵ [symbol] ^{m×n}. A process of estimating an optimal rank r of the parameter matrix may be expressed as argmin \tilde{w}∥W−\tilde{W}∥F. Here, W=XY^{T}. X∈ [symbol] ^{m×r}, Y∈ [symbol] ^{n×r}, and r<<min(m, n). [symbol] represents a transposed matrix. With low-rank parameterization, the number of parameters (the complexity of a matrix) is reduced from O(mn) to O((m+n)r). Here, the optimal values may be found by singular value decomposition.

Referring to FIG. 1, low-rank parameterization is the summation of 2R rank-1 matrices. FIG. 1 is one example of low-rank parameterization. FIG. 1 illustrates the case of 2R to facilitate description of a new parameterization technique. A rank resulting from low-rank parameterization has a value of rank(W)≤2R. General low-rank parameterization has limited expressiveness due to low-rank constraints. As a result, when matrix decomposition is applied to a neural network, the neural network model may show low performance.

As described above, related low-rank parameterization has the limitation of rank constraints. The following technology is a data reduction technology for reducing the number of parameters of a model without low-rank constraints. The following technology is parameterization without low-rank constraints and thus will be referred to as “full-rank reduced parameterization.”

FIG. 2 is an example of full-rank reduced parameterization. Full-rank reduced parameterization corresponds to the Hadamard product between two low-rank inner matrices. This is defined as W=W₁⊙W₂=(X₁Y₁^{T})⊙(X₂Y₂^{T}). ⊙ denotes the Hadamard product. The rank of full-rank reduced parameterization has a value of rank(W)≤R². Due to R², full-rank reduced parameterization has no low-rank constraint even when R is set to a small value to use a small number of parameters. Hereinafter, full-rank reduced parameterization is considered to be performed by a data processing device. The data processing device may be implemented in various forms, such as a personal computer (PC), a smart device, a server, a chipset into which a data processing program is embedded, etc.

It will be proved below that full-rank reduced parameterization minimizes the number of parameters and also has a characteristic of no rank constraint (a full rank).

Proposition 1: when X₁∈ [symbol] ^{m×r}^{₁}, X₂∈ [symbol] ^{m×r}^{₂}, Y₁∈ [symbol] ^{n×r}^{₁}, Y₂∈ [symbol] ^{n×r}^{₂}, and r₁ and r₂≤min(m, n), W:=(X₁Y₁^{T})⊙(X₂Y₂^{T}) is constructed. Then, rank(W)≤r₁r₂.

Proposition 1 will be proved now. X₁Y₁^{T} and X₂Y₂^{T} may be expressed as the summation of rank-1 matrices. XᵢYᵢ^{T}=Σⱼ₌₁^{j=r}^{ᵢ}xᵢⱼyᵢⱼ^{T}. x^{ij} and yᵢⱼ are j^{th} column vectors of Xᵢ and Yᵢ. Here, i∈{1,2}. In this case, W may be expressed by Expression 1 below.

$$W = {X}_{1} {Y}_{1}^{T} ⊙ {X}_{2} {Y}_{2}^{T} = \sum \text{?} {x}_{1 j} {y}_{1 j}^{T} ⊙ \sum \text{?} {x}_{2 j} {y}_{2 j}^{T} = \sum \text{?} \sum \text{?} ( {x}_{1 k} {y}_{1 k}^{T} ) ⊙ ( {x}_{2 j} {y}_{2 j}^{T} ) \qquad [ Expression 1 ]$$

$$\text{?} \text{indicates text missing or illegible when filed}$$

W is the summation of r₁r₂ rank-1 matrices. Since W is constructed with r₁×r₂ matrices, there are a maximum of r₁×r₂ number of vectors independent of each other. Accordingly, rank(W) has a maximal rank of r₁r₂.

Proposition 1 implies that, according to full-rank reduced parameterization, a higher-rank matrix can be calculated using the Hadamard product of two inner low-rank matrices W₁ and W₂. When inner ranks r₁ and r₂ satisfying r₁r₂≥min(m, n) are selected, the constructed matrix may achieve a full rank.

Proposition 2: Given R∈ [symbol] (natural number), r₁=r₂=R is the unique optimal choice of the criteria of Expression 2 below, and the optimal value is 2R(m+n).

argmin [symbol] (r₁+r₂)(m+n)s,t,r₁r₂≥R² [Expression 2]

Proposition 2 will be proved now. Expression 3 may be obtained using an arithmetic-geometric mean inequality and the given constraint.

(r₁+r₂)(m+n)≥2\sqrt{r₁r₂}(m+n)≥2R(m+n) [Expression 3]

The equality holds only when r₁=r₂=R by the arithmetic-geometric mean inequality.

Proposition 2 implies that, according to full-rank reduced parameterization with the rank constraint of the constructed matrix as R², the number of weight parameters is minimized. In other words, Proposition 2 implies that, although many values of r₁ and r₂ may be obtained from R², when the ranks of two low-rank matrices are set to the same value (r₁=r₂), the maximal rank R² is achieved, and the number of parameters is minimized. Proposition 2 proposes an efficient way to set the hyperparameters. In other words, when r₁=r₂=R and R² min(m, n), R can be set to a small value due to a characteristic of the square. Accordingly, full-rank reduced parameterization can ensure a much smaller number of parameters (2R(m+n)<<mn) than that of a native case without low-rank constraints.

Further, when the same number of parameters are given, rank(W) of full-rank reduction parameterization has a higher value than that of related low-rank parameterization by a square factor, as shown in FIG. 2.

Various applications to which full-rank reduced parameterization is applicable will be described below. Full-rank reduced parameterization is intended for lightening a model or a data structure and is applicable not only to the following exemplary embodiment but also in various other fields.

Researchers have verified the performance of the full-rank reduced parameterization described above by applying full-rank reduced parameterization to federated learning.

Proposition 1 is applicable to the tensor of a convolutional layer. The researchers reshaped a tensor kernel to the matrix as [symbol] ^{O×I×K}^{₁}^{×K}^{₂}→ [symbol] ^{O×(Ik}^{₁}^{K}^{₂₎}. Here, O denotes output channels, I denotes input channels, and K₁ and K₂ denote kernel sizes. In other words, full-rank reduced parameterization expands basis filters having a size of I×K₁×K₂. A model developer may control the number of parameters by changing the inner ranks r₁ and r₂.

The data processing device may achieve a full rank by setting the inner ranks r₁ and r₂ in accordance with Proposition 1 described above. Also, the data processing device may set the inner ranks r₁ and r₂ in accordance with Proposition 2 described above and achieve a maximal rank using a minimal number of parameters.

Also, the researchers have additionally extended full-rank reduced parameterization to a tensor structure as follows. However, the tensor structure extension described below is one exemplary embodiment of full-rank reduced parameterization.

Proposition 3: When [symbol] ₁, [symbol] ₂∈ [symbol] ^{R×R×k}^{₂}^{×k}^{₄}, X₁,X₂∈ [symbol] ^{k}^{₁}^{×R}, Y₁,Y₂∈ [symbol] ^{k}^{₂}^{2×R}, and R≤min(k₁, k₂), a convolution kernel is expressed as W:=( [symbol] ₁×₁X₁×₂Y₁)⊙( [symbol] ₂×₁X₂×₂Y₂). Here, the kernel satisfies rank(W⁽¹⁾)=rank(W⁽²⁾)≤R². T₁ and T₂ are tensors. k is a natural number.

Proposition 3 will be proved now. The first and second unfolded tensors may be expressed as Expression 4 below.

W⁽¹⁾=X₁ [symbol] ₁⁽¹⁾(I⁽⁴⁾ [symbol] I⁽³⁾⊗Y₁)^{T}) [symbol] (X₂ [symbol] ₂⁽¹⁾(I⁽⁴⁾ [symbol] I⁽³⁾⊗Y₂)^{T}), W⁽²⁾=Y₁ [symbol] ₁⁽²⁾(I⁽⁴⁾⊗I⁽³⁾⊗X₁)^{T})⊙(Y₂ [symbol] ₂⁽²⁾(I⁽⁴⁾⊗I⁽³⁾⊗X₂)^{T}), [Expression 4]

I⁽³⁾∈ [symbol] ^{k}^{₃}^{×k}^{₂} and I⁽⁴⁾∈ [symbol] ^{k}^{₄}^{×k}^{₂} are identity matrices. ⊗ is a Kronecker product. Since W⁽¹⁾ and W⁽²⁾ are matrices, Expression 1 is applicable. As a result, rank(W⁽¹⁾)=rank (W⁽²⁾)≤R².

Proposition 3 may be an extension of Proposition 1. Further, full-rank reduced parameterization may be used in designing a convolutional layer without reshaping. Accordingly, in terms of rank, full-rank reduced parameterization does not impose low-rank constraints, and thus performance can be maintained.

According to federated learning, local data of which privacy is important is not processed at the central server, and model learning is distributed to clients and cooperatively processed. Most clients are smartphones, Internet of things (IoT) devices, etc.

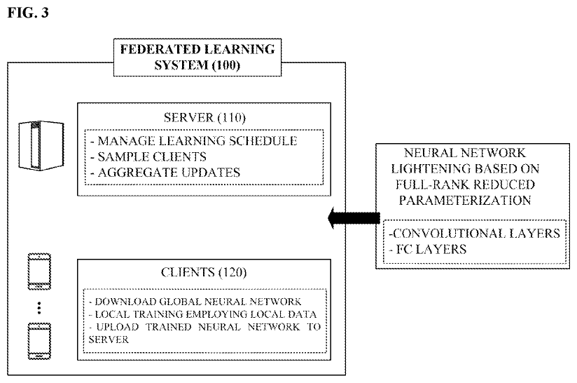

FIG. 3 is an example of federated learning to which full-rank reduced parameterization is applied. FIG. 3 shows an example of a federated learning system 100 to which full-rank reduced parameterization is applied.

First, a data processing device performs a neural network lightening process using full-rank reduced parameterization. The data processing device may lighten convolutional layers and/or FC layers. The data processing device may reduce the parameters of at least some of the convolutional layers. Also, the data processing device may reduce the parameters of at least some of the FC layers. The data processing device compresses the neural network through full-rank reduced parameterization. The data processing device may control the degree of compression (=the number of reduced parameters) in accordance with Proposition 1 or Proposition 2 described above. Meanwhile, the data processing device may be a computer device used for model development or a server 110 of FIG. 3.

The server 110 may construct or receive a global neural network model to be used in federated learning. Here, the neural network model is a model including layers which are lightened through full-rank reduced parameterization.

The server 110 basically manages a learning schedule and controls a learning process. The server 110 distributes the lightened global neural network model to clients 120. Each of the clients 120 downloads the global neural network model and performs local training on the global neural network model using local data thereof. The clients 120 may construct a parameter matrix by applying an Hadamard product to parameters received from the server 110 and perform training using the constructed parameter matrix.

The server 110 samples (selects) clients for training the global neural network model. The selected clients download the global model from the server 110 and upload neural networks (layers) locally trained by the clients to the server 110. The server 110 aggregates the trained neural networks received from the sampled clients.

Meanwhile, any one of various algorithms may be applied to federated learning. According to the above-described full-rank reduced parameterization, a neural network layer is decomposed in advance regardless of a learning algorithm. Accordingly, full-rank reduced parameterization is applicable to various learning models or learning algorithms.

As a result, the model size required for downloading and uploading is reduced, and thus federated learning to which full-rank reduced parameterization is applied reduces the cost of communication between a server and a client. Also, federated learning to which full-rank reduced parameterization is applied helps to alleviate the limitations of clients having limited resources.

Table 1 below shows the results of testing the performance of full-rank reduced parameterization at layers of a neural network model. Table 1 shows the results of an original model with no parameter change (Original), a model to which low-rank parameterization was applied (Low-rank), and a model to which full-rank reduced parameterization was applied (FedPara). Table 1 shows an example of the number of parameters (#Params), a maximal rank (Maximal Rank), etc. in accordance with a parameter lightening method (Parameterization). Table 1 shows results from an FC layer and a convolutional layer of the neural network model. In Table 1, the weights of the FC layer and the convolutional layer are assumed to be [symbol] ^{m×n} and [symbol] ^{O×I×K}^{₁}^{×K}^{₂} respectively. The rank of the convolutional layer is the rank of the first unfolded tensor. The sample is an example when m=n=O=I=256, K₁=K₂=3, and R=16.

TABLE 1

| Layer | Parameterization | # Params. | Maximal Rank | Example [# Params./Rank] |
|---|---|---|---|---|
| FC Layer | Original | mn | min(m, n) | 66K/256 |
| | Low-rank | 2R(m + n) | 2R | 16K/32 |
| | FedPara | 2R(m + n) | R³ | 16K/256 |
| Convolutional | Original | OIK₁K₂ | min(O, IK, K₃) | 590K/256 |
| Layer | Low-rank | 2R(O + I + RK₁K₂) | 2R | 21K/32 |
| | FedPara (Proposition 1) | 2R(O + IK₁K₂) | R² | 82K/256 |
| | FedPara (Proposition 3) | 2R(O + I + RK₁K₃) | R² | 21K/256 |

Referring to Table 1, Low-rank shows a reduced number of parameters, but a low maximal rank, and FedPara shows a reduced number of parameters and achieves the same rank as Original when R is appropriately selected. In the case of a convolutional layer, FedPara to which Proposition 1 is applied shows a slightly larger number of parameters than Low-rank while maintaining a full rank, but FedPara to which Proposition 3 is applied achieves a high rank while reducing the number of parameters like Low-rank.

A federated learning process employing the above-described full-rank reduced parameterization may be organized as Algorithm 1 in Table 2 below. Algorithm 1 is based on the assumption that a matrix for applying full-rank reduced parameterization to a specific layer is determined.

TABLE 2
Algorithm 1

| Input: rounds T [symbol] parameters X₁, X₂, Y₁, Y₂ | | |
|---|---|---|
| for t = 1, 2, . . . , T do | | |
| \| | Sample the subset S of clients; | |
| \| | Transmit X₁, X₂, Y₁, Y₂ to clients; | |
| \| | for c ∈ S do | |
| \| | \| | W = (X₁ Y₁^{τ}) ⊙ (X₂ Y₂^{τ}) ; |
| \| | \| | Optimizer(W); |
| \| | \| | Upload X₁, X₂, Y₁, Y₂; |

| | |
|---|---|
| \| | end |
| \| | Aggregate X₁, X₂, Y₁, Y₂; |

end

[symbol]

indicates data missing or illegible when filed

Algorithm 1 will be briefly described. A server transmits a lightened neural network to S sampled clients. The server transmits parameters X₁, X₂, Y₁, and Y₂ to the clients.

Each of the S clients performs a neural network learning process using local data thereof. As described above with reference to FIG. 2, the clients construct a parameter matrix W by calculating the Hadamard product of inner matrices W₁ and W₂ constructed with parameters. The clients perform learning using the parameter matrix W. When local learning is completed, the clients upload learned parameters X₁, X₂, Y₁, and Y₂ to the server. Then, the server aggregates learned parameters received from all the clients to construct a model.

As for clients participating in federated learning, data of the devices has different personal characteristics, and thus the independent and identically distributed (IID) assumption which is used in general learning does not hold. When any one client uses a model constructed through federated learning, the corresponding device may show low inference performance. Model personalization is a technique for calculating client-specific (user-specific) customized results. According to a related personalization technique, the layer of an output end of a model is personalized to generate a result in accordance with user data. The related personalization technique has a limitation that layers other than the output end are not personalized.

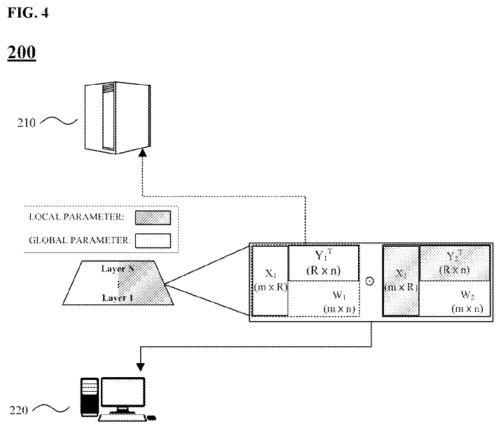

FIG. 4 is an example of a model personalization technique employing full-rank reduced parameterization. FIG. 4 corresponds to a personalization technique employing a characteristic structure of full-rank reduced parameterization. FIG. 4 illustrates a federated learning system 200. Referring to FIG. 4, model layers compressed by full-rank reduced parameterization include global parameters and local parameters. At one layer, a parameter matrix W may be expressed as the Hadamard product between a global weight W₁ and a local weight W₂.

It is assumed that a server 210 distributes a neural network model for federated learning to clients in advance, and the clients train the neural network model using local data thereof. For the convenience of description, FIG. 4 shows one client 220. In the training process, the client 220 trains parameter matrices of neural network layers using local data. The parameter matrix W is calculated as the Hadamard product between the global weight W₁ and the local weight W₂. When the training is finished, the client 220 transmits only the global weight W₁ to the server 210 and holds the local weight W₂ therein. Subsequently, the server 210 may aggregate neural network parameters and transmit completed global weights to the client 220.

At the client 220, a final weight W may be expressed as the summation of a personal weight and a global weight. W=W₁⊙W₂+W₁=Wₚₑᵣ+W_{glo}, Wₚₑᵣ=W₁⊙W₂, and W_{glo}=W₁. When such a model is used, the client 220 can globally show high inference performance due to federated learning and locally calculate a result in accordance with a personal characteristic thereof.

Although FIG. 4 has been described on the assumption of a federated learning system, the personalization technique of FIG. 4 may be used in devices that process other data or features as well as a neural network.

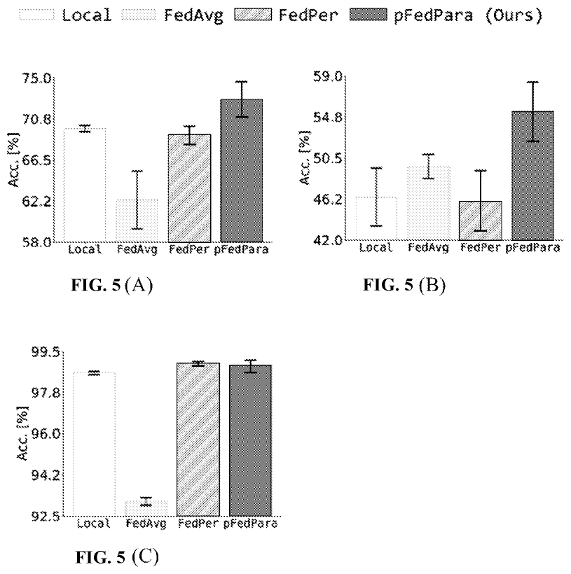

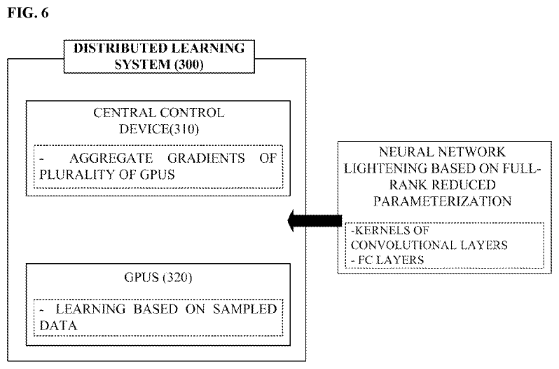

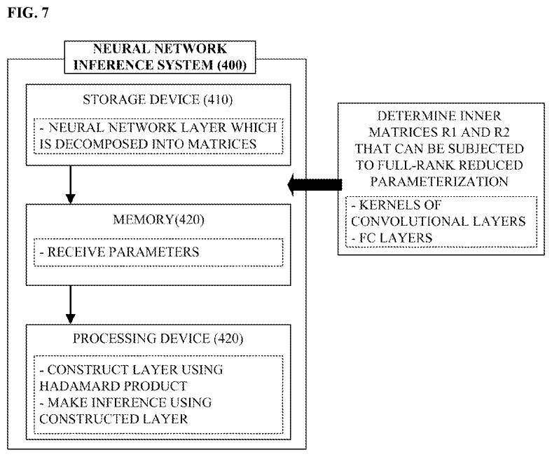

The researchers verified the performance of the model personalization technique by employing full-rank reduced parameterization. FIGS. 5(A), 5(B) and 5(C) show results of verifying the model personalization technique employing full-rank reduced parameterization. FIGS. 5(A), 5(B) and 5(C) provide an example of the accuracy of a neural network model. The researchers constructed a model for classifying image data using VGG16. In FIGS. 5(A), 5(B) and 5(C), “Local” represents an individual model other than a federated-learning-based model, “FedAvg” represents a related representative federated-learning model, “FedPer” represents a related representative personalization model, and “pFedPara” represents a personalization model based on full-rank reduced parameterization. pFedPara indicates a model constructed using the personalization technique described in FIG. 4.

FIGS. 5(A), 5(B) and 5(C) show results of three scenarios. The researchers distributed the Federated Enhanced Modified National Institute of Standards and Technology (FEMNIST) dataset. FIG. 5(A) is a comparative result of a case in which local training was performed using 100% FEMNIST local data which was non-IID training data. Since sufficient training data was used, Local showed higher accuracy than FedAvg and FedPer. However, pFedPara showed higher accuracy than Local. FIG. 5(B) is a comparative result of a case in which local training was performed using 20% FEMNIST data which was non-IID training data. This was a case in which training data was insufficient. Since training data was insufficient, Local showed lower accuracy than FedAvg. FedPer showed lower accuracy than FedAvg, which represents that performance is somewhat degraded when local data is insufficient. However, pFedPara showed the highest accuracy in the environment of FIG. 5(B) as well. FIG. 5(C) is a comparative result of a case in which local training was performed using 100% MNIST data which was highly skew non-IID training data. FedAvg showed remarkably lower accuracy than other models, which represents that accuracy is degraded with very biased data distribution. All the remaining models showed relatively high accuracy. Referring to the results of FIGS. 5(A), 5(B) and 5(C), pFedPara showed almost the highest performance in all the cases. pFedPara showed higher performance than a model trained on a single device rather than a model subjected to federated learning.

FIG. 6 is an example of distributed learning to which full-rank reduced parameterization is applied. FIG. 6 shows an example of a distributed learning system 300 to which full-rank reduced parameterization is applied.

The distributed learning system 300 performs learning in parallel using a plurality of graphics processing units (GPUs) 320. A central control device 310 may be a computing device other than a GPU that performs learning or one of the GPUs 320. The distributed learning system 300 divides a model or data using the plurality of GPUs 320 to perform learning. Since a huge neural network model has a large number of parameters, a distributed learning process of the model may have a communication bottleneck in a gradient sharing process.

First, a data processing device performs a neural network lightening process employing full-rank reduced parameterization. The data processing device may reduce the weights of convolutional layers and/or FC layers. The data processing device may reduce the number of parameters of at least some of the convolutional layers. Also, the data processing device may reduce the number of parameters of at least some of the FC layers. The data processing device compresses the neural network through full-rank reduced parameterization. The data processing device may control the degree of compression (=the number of reduced parameters) in accordance with Propositions 1 to 3 described above. Meanwhile, the data processing device may be a computer device used for model development or the central control device 310 of FIG. 6.

Each of the plurality of GPUs 320 is assumed to have a neural network model and data to be used in learning. Each of the plurality of GPUs 320 trains the assigned neural network using sampled data.

As a gradient aggregation process, the single central control device 310 aggregates all gradients, or all the GPUs 320 may share gradients by transmitting the gradients in a ring form. FIG. 6 shows an example in which a central control device (=a parameter server) aggregates gradients. The GPUs 320 transmit a parameter matrix or parameters of a neural network layer which is lightened through full-rank reduced parameterization to the central control device 310. Unlike in FIG. 6, while the GPUs 320 share gradients, any one GPU transmits a parameter matrix or parameters updated by the GPU to another GPU. Accordingly, distributed learning to which full-rank reduced parameterization is applied involves a reduced amount of network communication, and thus communication cost is reduced.

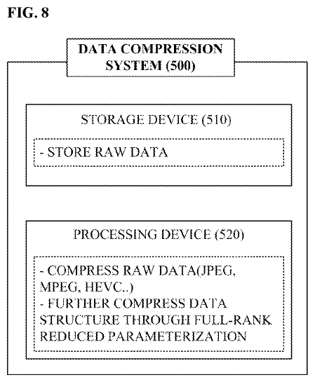

FIG. 7 is an example of a neural network inference technique to which full-rank reduced parameterization is applied. FIG. 7 shows an example of a neural network inference system 400 employing a neural network model to which full-rank reduced parameterization is applied. The neural network inference system 400 may be hardware having a limited memory capacity. It may be difficult for the neural network inference system 400 to make an inference by reading a neural network layer at once. The neural network inference system 400 repeats a process of reading parameters of a neural network, processing data, and processing data of a next layer. The neural network inference system 400 requires a communication time to read parameters from a storage device 410 to a memory 420. In the neural network inference system 400, a communication time may be longer than a computing time of the processing device 420. In this case, when the neural network model is lightened through full-rank reduced parameterization, communication cost can be reduced, and the inference performance of the neural network inference system 400 can be improved.

First, a data processing device performs a neural network lightening process employing full-rank reduced parameterization. The data processing device may reduce the weights of convolutional layers and/or FC layers. The data processing device may reduce the number of parameters of at least some of the convolutional layers. Also, the data processing device may reduce the number of parameters of at least some of the FC layers. The data processing device compresses the neural network through full-rank reduced parameterization. The data processing device may control the degree of compression (=the number of reduced parameters) in accordance with Propositions 1 to 3 described above. Meanwhile, the data processing device may be a computer device used for model development.

The storage device 410 stores neural network layer data which is decomposed into matrices through full-rank reduced parameterization. The memory 420 reads a parameter W₁ and a parameter W₂ from which a parameter matrix W is constructable from the storage device 410. The processing device 420 calculates the Hadamard product of the parameter W₁ and a parameter W₂ as the parameter matrix W to construct a corresponding layer. The processing device 420 may perform an inference process using the constructed layer.

FIG. 8 is an example of a data compression technique to which full-rank reduced parameterization is applied. FIG. 8 shows an example of a data compression system 500 to which full-rank reduced parameterization is applied.

A storage device 510 stores raw data of digital content.

A processing device 520 first compresses data using a standardized compression method in accordance with basic quality for storage. The compression method may vary, such as Joint Photographic Experts Group (JPEG), Moving Picture Experts Group (MPEG), High Efficiency Video Coding (HEVC), etc., depending on a type of content and a coding protocol.

In this case, the structure of the first compressed data may be considered a vector. Accordingly, the above-described full-rank reduced parameterization may be applied to the compressed data. The processing device 520 may lighten the first compressed data through full-rank reduced parameterization to reduce the amount of the data.

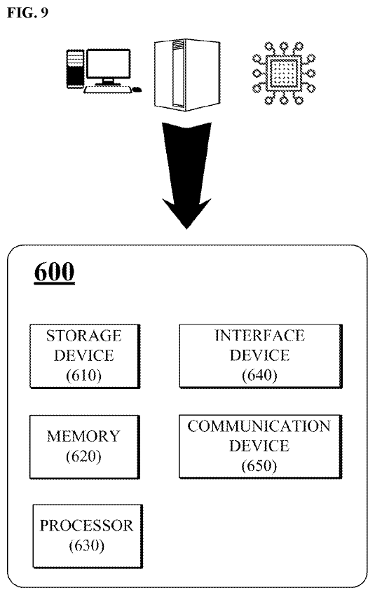

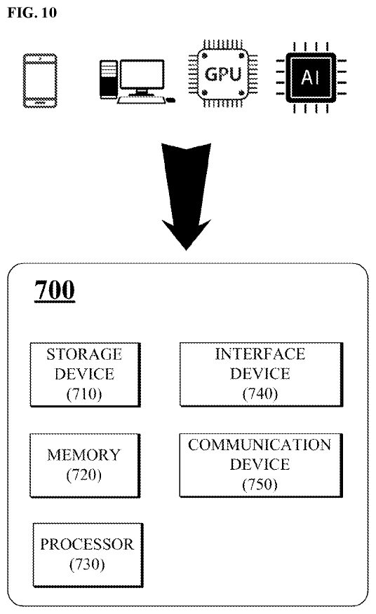

FIG. 9 is an example of a data processing device 600 that performs full-rank reduced parameterization. The data processing device 600 is a device that reduces the weight of data or a neural network model. The data processing device 600 may be implemented as a PC, a server, a chipset in which a program is embedded, a smart device, etc.

The data processing device 600 may include a storage device 610, a memory 620, a processor 630, an interface device 640, and a communication device 650.

The storage device 610 may store a data structure or neural network model to be lightened.

The storage device 610 may store a program or code (instructions) for full-rank reduced parameterization.

The storage device 610 may store lightened data, neural network layers, or parameter matrices.

The memory 620 may store data, information, etc. generated in a process in which the data processing device 600 performs full-rank reduced parameterization.

The memory 620 reads necessary neural network models, program code, instructions, etc. from the storage device 610 while performing full-rank reduced parameterization.

The interface device 640 is a device that receives certain external instructions and data. The interface device 640 may receive initial data or an initial neural network model from a physically connected input device or external storage device. The interface device 640 may also transmit the lightened data, neural network layers, or parameter matrices to other objects.

The communication device 650 is an element that receives and transmits certain information through a wired or wireless network. The communication device 650 may receive the initial data or the initial neural network model from an external object. The communication device 650 may transmit the lightened data, neural network layers, or parameter matrices to an external object such as a user terminal, a service server, etc.

The following description is based on the description and expressions of full-rank reduced parameterization provided with reference to FIGS. 2, 3, etc.

The processor 630 performs full-rank reduced parameterization while executing program code (instructions) stored in the memory 620.

The processor 630 calculates inner matrices W₁ and W₂ through full-rank reduced parameterization described above with reference to FIG. 2.

As described above, the processor 630 may control the number of parameters in accordance with the target degree of compression.

The processor 630 may control the degree of compression in accordance with Propositions 1 to 3 described above. The processor 630 may select low ranks r₁ and r₂ satisfying r₁r₂≥min(m, n) in accordance with Proposition 1 (Expression 1) in the matrix structure shown in FIG. 2. In this case, a corresponding parameter matrix W may logically achieve a full rank.

When r₁=r₂=R and R²≥min(m, n) in accordance with Proposition 2 (Expressions 2 and 3), the processor 630 may achieve a maximal rank using a minimal number of parameters.

When a matrix is constructed to satisfy Proposition 3 (Expressions 1 and 4) with respect to a convolutional layer of the neural network, the processor 630 may achieve a full rank with a minimal number of parameters without reshaping the convolutional layer. Here, matrices X₁ and X₂ have a size of k₁×R, matrices Y₁ and Y₂ have a size of k₂×R, and T₁ and T₂ have a size of R×R×k₃×k₄.

The processor 630 may reduce the weights of parameters of the neural network layers, parameters of the data structure expressed as a vector, and parameters of data expressed as a matrix structure.

The processor 630 may be a device that processes data and certain operations such as a processor, an application processor (AP), or a chip into which a program is embedded.

FIG. 10 is an example of a client 700 that executes a certain application using lightened data. The client 700 may be implemented in various forms such as a client of federated learning, a client employing a personalized neural network model, a GPU of distributed learning, an artificial intelligence (AI) processor that makes an inference using a neural network model, the electronic control unit (ECU) of a vehicle, an encoding device that compresses digital data, etc.

The client 700 may include a storage device 710, a memory 720, a processor 730, and an interface device 740. Further, the client 700 may include a communication device 750.

The storage device 710 may store a neural network model which is lightened through full-rank reduced parameterization. In other words, the storage device 710 may store a parameter matrix determined by the above-described data processing device 600.

The storage device 710 may store training data for training a neural network model.

The storage device 710 may store a program or code (instructions) for inference through the neural network model.

The memory 720 may store data, information, etc. generated in an inference process, a data compression process, etc. through the neural network model.

The memory 720 reads necessary program code or instructions from the storage device 710.

The interface device 740 is a device to which certain external instructions and data are input. The interface device 740 may receive a lightened neural network model from a physically connected input device or external storage device. Input data for the trained neural network model may be input to the interface device 740.

The interface device 740 may also transmit parameters learned using the neural network model, an inference result obtained through the neural network model, etc. to an external object.

The communication device 750 is an element that receives and transmits certain information through a wired or wireless network. The communication device 750 may receive the lightened neural network model from an external object. The communication device 750 may receive the input data for the trained neural network model. Also, the communication device 750 may transmit the parameters learned using the neural network model, the inference result obtained through the neural network model, etc. to an external object such as a user terminal, a service server, etc.

The processor 730 performs a process, such as neural network learning, inference through the trained neural network, data compression, etc., while executing program code (instructions) stored in the memory 720.

The processor 730 may calculate the Hadamard product of the inner matrices W₁ and W₂ determined through full-rank reduced parameterization to construct a parameter matrix.

The processor 730 may update parameters of the constructed parameter matrix while performing a learning process using training data. Clients of federated learning or GPUs of distributed learning perform the operation.

The processor 730 may also make an inference using the trained neural network model. As described above with reference to FIG. 7, the processor 730 may calculate the Hadamard product of the inner matrices W₁ and W₂ which are obtained through matrix decomposition to construct a neural network layer and make an inference by inputting input data or an output of a previous layer to the constructed layer.

The processor 730 may be a device that processes data and certain operations such as a processor, an AP, or a chip into which a program is embedded.

The client 700 may be a device that performs model personalization using full-rank reduced parameterization.

The storage device 710 may store program code or instructions for a process of performing neural network model personalization and making an inference using a personalized model.

The memory 720 may read instructions required for a data personalization or model personalization process from the storage device 710.

While executing the instructions stored in the memory 720, the processor 730 performs a data personalization process, a neural network model personalization process, or an inference process employing a personalized model.

The parameter matrix W is a matrix calculated as the Hadamard product between the global weight W₁ and the local weight W₂. The processor 730 updates the weights of the parameter matrix W using training data thereof. When the training is finished, the interface device 740 or the communication device 750 transmits only the updated global weight W₁ to a server. The interface device 740 or the communication device 750 may receive a global weight W′₁ which is a gradient aggregation result for a specific layer from the server. The storage device 710 stores the global weight W′₁ for the specific layer and the local weight W₂. Subsequently, the processor 730 calculates the Hadamard product of the global weight W′₁ for the specific layer and the local weight W₂ to generate a parameter matrix W′. The processor 730 makes an inference by inputting input data thereof or an output of a previous layer to the specific layer.

The above-described full-rank reduced parameterization method, full-rank reduced parameterization-based personalization method, federated learning method, distributed learning method, neural network-based inference method, and data compression method may be implemented as a program (or an application) including a computer-executable algorithm. The program may be stored in a transitory or non-transitory computer-readable medium and provided.

The non-transitory computer-readable medium is a medium that stores data semi-permanently rather than storing data for a short time, such as a register, a cache, a memory, etc., and is readable by a device. Specifically, the foregoing various applications or programs may be stored in the non-transitory computer-readable medium, such as a compact disc (CD), a digital versatile disc (DVD), a hard disk, a Blu-ray disc, a Universal Serial Bus (USB) device, a memory card, a read-only memory (ROM), a programmable read-only memory (PROM), an erasable PROM (EPROM), an electrically EPROM (EEPROM), a flash memory, etc., and provided.

The transitory computer-readable medium is one of various random access memories (RAMs) such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), and a direct Rambus RAM (DRRAM).

A program or instructions for the foregoing various applications are as follows. The following description is based on the lightening process and structure described above with reference to FIGS. 2, 3, etc.

A storage medium or memory may store instructions for controlling data reduction. The instructions may include code for controlling an operation in which a memory receives data expressed as a vector matrix and an operation in which a processor determines low-rank matrices W₁ and W₂ from which a target parameter matrix W is constructable. The target parameter matrix W may be constructed as the Hadamard product between the matrices W₁ and W₂, the matrix W₁ may be constructed as the inner product of a matrix X₁ having a size of m×r₁ and a matrix Y₁ having a size of n×r₁, and the matrix W₂ may be constructed as the inner product of a matrix X₂ having a size of m×r₂ and a matrix Y₂ having a size of n×r₂. The instructions may include code for controlling a process in which the processor determines the matrices W₁ and W₂ to satisfy r₁×r₂≥min(m, n). The instructions may include code for controlling a process in which the processor determines the matrices W₁ and W₂ to satisfy r₁=r₂=R and R²≥min(m, n). The instructions may include code for controlling a process in which the processor determines W₁ and W₂ to satisfy R≤min(k₁, k₂) when the matrices X₁ and X₂ have a size of k₁×R and the matrices Y₁ and Y₂ have a size of k₂×R.

The storage medium or memory may store instructions for controlling neural network learning employing a lightened neural network model. Here, the neural network learning may be federated learning, distributed learning, etc. It is assumed that a target layer among neural network layers is lightened through the above-described data reduction process. The target layer may be at least some (including all) of convolutional layers and/or at least some (including all) of FC layers. The instructions may include code for controlling an operation in which the memory receives the low-rank matrices W₁ and W₂ for constructing a target parameter matrix, an operation in which the processor calculates the Hadamard product between the low-rank matrices W₁ and W₂ to construct the target parameter matrix W, and an operation in which the processor updates the target parameter matrix W using a feature extracted from training data.

The storage medium or memory may store instructions for controlling inference employing a lightened neural network model. The neural network may have any one of various structures. It is assumed that a target layer among neural network layers is lightened through the above-described data reduction process. The target layer may be at least some (including all) of convolutional layers and/or at least some (including all) of FC layers. The instructions may include code for controlling an operation in which the memory receives the low-rank matrices W₁ and W₂ for constructing a target parameter matrix, an operation in which the processor calculates the Hadamard product between the low-rank matrices W₁ and W₂ to construct the target parameter matrix W, and an operation in which the processor inputs input data or a feature transferred from the previous layer of the target layer to the target layer to make an inference.

The storage medium or memory may store instructions for controlling personalization employing lightened data or a lightened neural network model. The neural network may have any one of various structures. The lightened data may include global data and local (personal) data. The instructions may include code for controlling an operation in which the memory receives the low-rank matrix W₁ for the global data and the low-rank matrix W₂ for the local data which are determined in a data reduction process in accordance with the above-described data reduction method, an operation in which the processor generates a target parameter matrix W as an Hadamard product between the low-rank matrices W₁ and W₂, and an operation in which the processor trains the neural network model or makes an inference based on the neural network model using the target parameter matrix W. The low-rank matrix W₁ for the global data is calculated as a result of learning from the global data by at least one device other than the device. Also, the instructions may include code for controlling an operation of transmitting low-rank inner matrices for constructing a matrix corresponding to global data to an external object, such as a server, and an operation of receiving the matrix W₁ which is updated global data from the external object.

According to the above-described technology, it is possible to ideally achieve a full rank while reducing the number of parameters. Accordingly, the above-described technology reduces the amount of communication while maintaining the model capacity of an application such as neural network learning or inference. Further, according to the above-described technology, individual matrices derived from a lightening process can be classified as global information and local (personal) information and used for data personalization.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A data reduction method performed by a device including a processor and a memory configured to store instructions for controlling the processor to perform data reduction, the data reduction method comprising:
receiving, by the memory, data expressed as a vector matrix; and
determining, by the processor, low-rank matrices W₁ and W₂ from which a target parameter matrix W is constructable,
wherein the target parameter matrix W is constructed as an Hadamard product between the low-rank matrices W₁ and W₂,
the low-rank matrix W₁ is constructed as an inner product of a matrix X₁ having a size of m×r₁ and a matrix Y₁ having a size of n×r₁, and
the low-rank matrix W₂ is constructed as an inner product of a matrix X₂ having a size of m×r₂ and a matrix Y₂ having a size of n×r₂ (m, n, r₁, and r₂ are natural numbers).

2. The data reduction method of claim 1, wherein the data includes parameters of a convolutional layer of a neural network or parameters of a fully connected (FC) layer of the neural network.

3. The data reduction method of claim 1, wherein the processor determines the low-rank matrices W₁ and W₂ to satisfy r₁×r2≥min(m, n).

4. The data reduction method of claim 1, wherein the processor determines the low-rank matrices W₁ and W₂ to satisfy r₁=r₂=R and R²≥min(m, n) (where R is a natural number).

5. The data reduction method of claim 1, wherein the data is a tensor of a neural network layer,
the tensor has a size of R×R×k₃×k₄,
each of the matrices X₁ and X₂ has a size of k₁×R, and
each of the matrices Y₁ and Y₂ has a size of k₂×R (where R and k are natural numbers).

6. A neural network model training method performed by a device including a processor and a memory configured to store instructions for controlling the processor to train a neural network model on a target layer which is lightened in accordance with the data reduction method of claim 1 among layers of the neural network model, the neural network model training method comprising:
receiving, by the memory, low-rank matrices W₁ and W₂ for constructing a target parameter layer of the target layer;
calculating, by the processor, an Hadamard product of the low-rank matrices W₁ and W₂ as a target parameter matrix W; and
updating, by the processor, the target parameter matrix W using a feature extracted from training data,
wherein the target layer is any one of convolutional layers or any one of fully connected (FC) layers.

7. An inference method performed using a neural network model by a device including a processor and a memory configured to store instructions for the processor to control an inference process employing the neural network model on a target layer which is lightened in accordance with the data reduction method of claim 1 among layers of the neural network model, the inference method comprising:
receiving, by the memory, low-rank matrices W₁ and W₂ for constructing a target parameter matrix of a target layer;
calculating, by the processor, an Hadamard product between the low-rank matrices W₁ and W₂ to construct a target parameter matrix W; and
inputting, by the processor, input data or a feature transferred from a previous layer of the target layer to make an inference,
wherein the target layer is any one of convolutional layers or any one of fully connected (FC) layers.

8. A data personalization method performed by a device including a processor and a memory configured to store instructions for controlling the processor to operate using global data and local data having a device-dependent feature, the data personalization method comprising:
receiving, by the memory, a low-rank matrix W₁ for the global data and a low-rank matrix W₂ for the local data which are determined in a data reduction process in accordance with the data reduction method of claim 1;
generating, by the processor, a target parameter matrix W as an Hadamard product of the low-rank matrices W₁ and W₂; and
training, by the processor, the neural network model or making an inference based on the neural network using the target parameter matrix W,
wherein the low-rank matrix W₁ for the global data is calculated as a result of learning from the global data by at least one device other than the device.

9. A data processing device comprising:
a memory configured to store target data expressed as a vector matrix and instructions for performing control over data reduction; and
a processor configured to determine low-rank matrices W₁ and W₂ from which a target parameter matrix W is constructable,
wherein the target parameter matrix W is constructed as an Hadamard product between the low-rank matrices W₁ and W₂,
the low-rank matrix W₁ is constructed as an inner product of a matrix X₁ having a size of m×r₁ and a matrix Y₁ having a size of n×r₁, and
the low-rank matrix W₂ is constructed as an inner product of a matrix X₂ having a size of m×r₂ and a matrix Y₂ having a size of n×r₂ (where m, n, r₁, and r₂ are natural numbers).

10. The data processing device of claim 9, wherein the processor determines the low-rank matrices W₁ and W₂ to satisfy r₁×r2≥min(m, n).

11. The data processing device of claim 9, wherein the processor determines the low-rank matrices W₁ and W₂ to satisfy r₁=r₂=R and R²≥min(m, n).

12. The data processing device of claim 9, wherein the data is a tensor of a neural network layer,
each of the matrices X₁ and X₂ has a size of k₁×R, and
each of the matrices Y₁ and Y₂ has a size of k₂×R.
